(19) United States
(12) Patent Application Publication
(10) Pub. No.: US 2002/0083313 A1
(43) Pub. Date: Jun. 27, 2002

(54) Data processing apparatus with many-operand instruction

(76) Inventors: Bernardo De Oliveira Kastrup Pereira, Eindhoven (NL); Marco Jan Gerrit Bekooij, Eindhoven (NL); Albert Van Der Werf, Eindhoven (NL)

Correspondence Address: U.S. Philips Corporation, 580 White Plains Road, Tarrytown, NY, 10591, US

(21) Appl. No.: 09/994,363

(22) Filed: Nov. 26, 2001

(30) Foreign Application Priority Data
Nov. 27, 2000 (EP) 00204203.4

(51) Int. Cl. G06F 9/30

(52) U.S. Cl. 712/245; 712/214; 712/220

(57) ABSTRACT

A data processing apparatus is capable of executing an operation that requires many more operands than can be provided in a single instruction. An original instruction starts execution of the operation and other, operand supplying instructions that follow each other in time are used to supply the operands for that operation. When such an operand supplying instruction is not supplied in time, execution of the original instruction is suspended.

The invention relates to a data processing apparatus.

Conventional data processors have instructions that specify the register location of a relatively small number of operands (typically two operands) and a small number of results (typically one). Some operations, like for example a two-dimensional Discrete Cosine Transform (DCT), require a significantly larger number of operands. It is difficult to provide for a single instruction that commands such an operation, because the large number of required operands and/or results makes the instruction and its and its access path to operand registers uneconomically wide. Therefore, such an operation is usually broken down into a number of general purpose instructions that each access a small number of registers. This has the disadvantage that intermediate results have to be sent back and forth to the registers for use by different instructions.

One known way to improve on this is to store the operands and result in an area of contiguous memory locations. In this case the instruction that starts the operation needs to specify only the starting address of that area. The processor can fetch the operands in successive processing cycles, using the starting address to determine the location of the operands. Use of memory makes this operation slow, especially when it is executed in parallel with other operations. It would be preferable to use registers for storing operands and data. However, this would require the reservation of a large block of registers for a large number of processing cycles. This makes it difficult to schedule other instructions efficiently, if these other instructions also use registers.

A data processor that can handle a large number of operands from registers more efficiently is known from a conference paper titled “Scheduling coarse grained operations for VLIW processors” by N.Busa et al. presented at the ISSS conference in Madrid, 2000. When this processor receives an instruction that requires a large number of operands, the processor reads the operands in successive processing cycles following reception of the instruction. For each of these processing cycles a further instruction is issued that specifies a register from which an operand for that processing cycle should be read. The further instruction merely serves to identify the location of some of the operands. The multi-operand operation is defined by the original instruction and execution of the operation proceeds during a time interval that extends both before and after execution of the further instruction. The further instruction directs the functional unit to fetch the operand from the specified register, for use in the multi-operand operation commanded by the original instruction.

Not only does this make it possible to use an in theory unlimited number of operands for a multi-operand operation, it can also be used to reduce the number of different registers that is needed for supplying the operands of the multi-operand operation. Once the instruction to fetch an operand from a specified register has been executed, other data can be written into that register even before all remaining operands for the multi-operand operation have been specified. This other data may include other operands that will be fetched for use in the multi-operand operation under direction from a subsequent instruction.

Execution of the multi-operand operation starts in response to the original instruction, that is, before all operands have been specified. For example, in case of the two dimensional DCT, execution can perform the first computation step using a first row of the two-dimensional block that must be transformed before the other rows have been read. As a result, the time needed by other functional units to produce the operands can be overlapped with the time needed to perform the operation on the operands, increasing the speed of the processor. This is useful for example in VLIW processors, which can execute a number of instructions in parallel, and in superscalar processors.

Similarly, different results of the operation can be written to the registers in different instruction cycles. For this purpose, further instructions are provided, which specify registers for writing results. This also leads to more efficient use of registers and increased parallelism in execution.

The instructions that command the functional unit to fetch the operands and to write the parts of the results to the register file have to be scheduled by a compiler or a scheduler. The compiler or scheduler has to determine for each respective instruction when (in which instruction cycle) the instruction has to be issued to the functional unit. When the compiler decides to schedule an instruction that reads operands (or writes results) in a large number of execution cycles after issue of the instruction, the compiler also needs to schedule the instructions that specify the registers from which the operands are to be read (or written) in different steps of the computation. This means that a large number of instructions have to be scheduled as a block in fixed time relation. However, this has the disadvantage that it limits the flexibility for scheduling other instructions. The instructions that produce the operands must write each operand before the execution of the instruction that reads the operand (a similar constraints holds for use of the results). Thus the block of instructions imposes severe constraints on those producing instructions, which may lead to inefficient use of resources like registers and functional units.

The cited article describes how these constraints can be relaxed by scheduling a “HALT” instruction, which causes suspension of the operation that reads the operands and writes the results. The processor expects all operands of the operation that are read after the HALT instruction one instruction cycle later (and similarly it writes all results one instruction cycle later). Thus, execution of the HALT instruction creates additional time for executing instructions that produce the operands or consume the results. In this way more flexible scheduling is possible, making it possible to conserve resources.

However, halt instructions are additional instructions that need to be issued, thus increasing the required memory space for the program and obstructing the issue of other instructions.

Amongst others, it is an object of the invention to provide for flexibility of instruction scheduling, without requiring additional instructions in a data processing apparatus that can execute an instruction that commands a computation which requires a plurality of operands that are read in different instruction cycles under selection by different instructions.

The data processing apparatus according to the invention is set forth in claim 1. The data processing apparatus executes a program of machine instructions. Normal instructions are self-contained, specifying the operation that is to be executed, the location of the operands and of the result, but at least one type of instruction causes the apparatus to start execution of a computation that requires the specification of operands by subsequent instructions. According to the invention, an operand selection instruction that is used to specify an operand after the computation has been started also serves to control progress of execution of the computation. Other instructions may be executed while the computation is suspended, waiting for the next operand selection instruction. A functional unit starts the computation in response to an original instruction. If the operand selection instruction is issued within a predetermined time interval after the original instruction, the computation proceeds normally, without interruption. If the operand selection instruction is issued later, execution of the computation is suspended until the operand selection instruction is issued. This allows the compiler or scheduler the flexibility to select the time when the operand selection instruction is to be scheduled, leaving room for scheduling intermediate instructions to generate the operand or to free a register for use for the operand. In this way, more instruction schedules can be realized, that make more efficient use of resources.

In a preferred embodiment, the functional unit monitors the operation codes issued to the functional unit during execution of the computation, in order to detect the operand selection instruction from its operation code. If the operation code is not detected, execution of the multi-operand instruction is suspended. This provides for a simple implementation without the need for a complex handshake mechanism. Preferably the register selection code from this operand selection instruction is fed directly to a port of the register file that is attached to the functional unit, independent of the value of the operation code. However, suspension of the computation dependent on the operand selection instruction may also be realized for example in the functional unit by monitoring the ports by which the functional unit is connected to the register file, in order to detect when the operand becomes available in response to the operand selection instruction. There might even be a FIFO queue between the ports and the functional unit, to allow buffering of more than one operand.

In an embodiment of the processing apparatus according to the invention, the sequence in which the steps of the computation are executed is guided by the operand selection instruction. Thus, the compiler or scheduler gets the freedom to influence the sequence in which the steps of the computation are executed. The compiler or scheduler can use this freedom for example to adapt the sequence to the available of resources to generate the operand. This leads to more efficient schedules.

In another embodiment of the processing apparatus according to the invention suspension of the computation depends on both the issue of the operand selection instruction and the validity of the specified operand. In this case, the program of the processing apparatus is arranged to issue the operand selection instruction a number of times, for example during different executions of a loop body. In addition to the operand register the operand selection instruction specifies a signal register for a signal that indicates whether the content of the register for the operand already represent a valid operand. The functional unit suspends operation until an operand selection instruction has been issued which produces in a valid operand.

In another embodiment of the processing apparatus according to the invention execution of steps of the computation is also suspended when a result specification instruction that specifies a register for storing result data is not received within a predetermined time interval. Preferably detection of the result specification instruction is implemented by detecting the operation code of the result specification instruction of an an instruction issued to the functional unit.

In a further embodiment of the processing apparatus according to the invention, the result specification instruction also specifies a signal register, for storing a signal to indicate whether the result is valid. The functional unit stores this signal in the specified signal register. In this way, the functional unit can proceed even though the result is not yet available at the time the result specification instruction is issued, for example because the amount of time needed to produce a new result depends on the operands.

These and other advantageous aspects of the processing apparatus according to the invention will be described in more detail using the following figures.

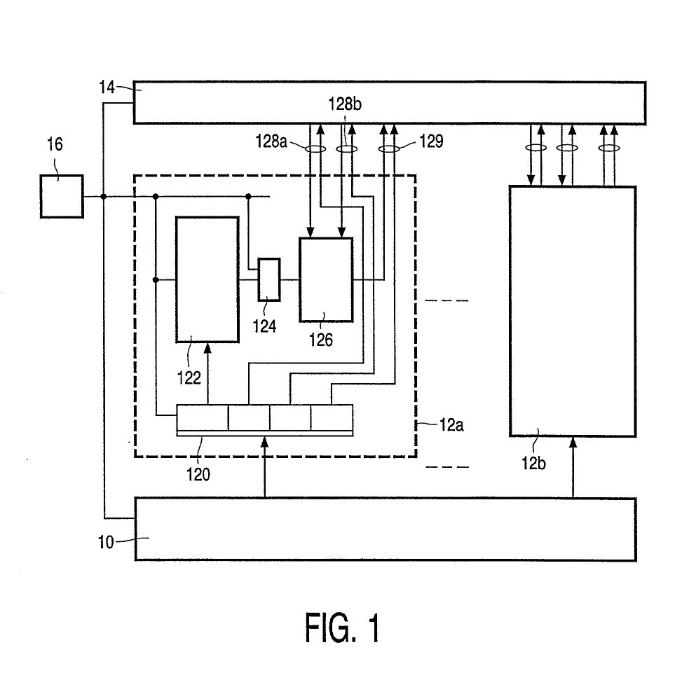

FIG. 1 shows a processor;

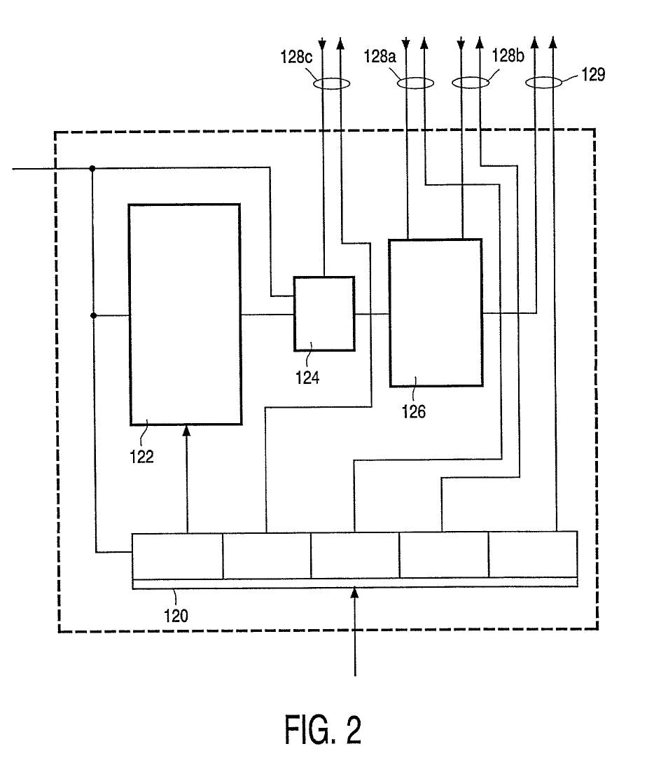

FIG. 2 shows a functional unit.

FIG. 1 shows a processor that contains an instruction issue unit 10, a number of functional units 12a, b, a register file 14 and an instruction clock 16. By way of example a VLIW (Very Large Instruction Word) type processor is shown. The instruction issue unit 10 has instruction outputs connected to the various functional units 12a, b. The functional units 12a, b are connected to ports of the register file 14. The instruction clock 16 is connected to the instruction issue unit 10, the functional units 12a, b, and the register file 14.

FIG. 1 shows one of the functional units 12a in more detail. The functional unit 12a contains an instruction register 120, an instruction decoder 122, a clock gate 124, an execution unit 126, read ports 128a, b and a write port 129. The instruction register 120 has an input coupled to the instruction issue unit 10, an operation code output coupled to the instruction decoder 122, operand selection outputs coupled to read ports 128a, b and a result selection output coupled to write port 129. The read ports 128a, b and the write port 129 are connected to the register file 14. Instruction decoder is coupled to execution unit 126. Instruction clock 16 is coupled to the instruction register 120 and the instruction decoder 122. Instruction clock 16 is coupled to execution unit 126 via clock gate 124. Clock gate 124 has an enable input coupled to instruction decoder 122.

In operation, instruction issue unit 10 issues instructions to the functional units 12a, b. In each instruction cycle, as indicated by the instruction clock 16, new instructions are issued to the functional units 12a, b. For this purpose, instruction issue unit preferably contains an instruction memory (not shown explicitly) and a program counter (not shown explicitly), for representing an address in the instruction memory from which the next instruction should be fetched. The program counter is incremented in each instruction cycle, or changed to a branch target value in response to a branch instruction.

Normally, each instruction contains an operation code, two operand register selection codes and one result register selection code. The operation code specifies the type of operation that should be executed by the functional unit 12a, b in response to the instruction. The operand register selection codes specify the registers in the register file 14 from which the operands for the operation should be fetched. The result register selection code specifies the register in the register file 14 to which the result of the operation should be written.

Functional unit 12a receives the instruction from instruction issue unit 10 and stores the instruction in instruction register 120. The instruction register 120 has fields for the operation code, the operand register selection codes and the result register selection codes. The content of the field for the operation code is fed to the instruction decoder 122. The contents of the fields for the operand register selection codes are fed to the register address parts of the read ports 128a, b to the register file 14. The content of the fields for the result register selection codes is fed to the register address parts of the write port 129 to the register file 14. The instruction decoder 122 decodes the instruction and in response feeds appropriate control codes to the execution unit 126. The register file 14 receives the register addresses, and outputs the data from the addressed registers to the execution unit 126 via the read ports 128a, b. The execution unit 126 uses the data from the read ports in the execution of operations (e.g. addition) and outputs a result to the write port 129.

In the processor, a plurality of functional units (not shown) may be connected to the same read and write ports and the same output of the instruction issue unit 10. In this case, the instruction issued by the instruction issue unit 10 determines which of those functional units executes the instruction, using the operand registers and writing to the result register specified in the instruction.

Preferably, the processor of FIG. 1 is a pipelined processor, in which different stages of execution of successive instructions are executed in parallel. Thus, for example, operands are fetched from the register file 14 during the execution of the computation ordered by an earlier instruction and during write back of the result of an even earlier instruction. Similarly, when the operands are fetched instruction issue unit 10 will be fetching a later instruction. This realized by giving various delays to signals involved with instruction execution. To simplify the illustration of the invention, this pipeline aspect will be left implicit in the discussion of FIG. 1. All pipeline stages of instruction execution of the same instruction will be discussed as one stage.

Normally, execution of successive instructions by a functional unit 12a, b is independent. The operation executed in response an instruction is always the same, independent of instructions that have been executed earlier by the functional unit. At the most, but this is unusual, the functional unit 12a, b retains a condition code for use during execution of a later instruction. In each instruction cycle, execution of a new instruction can be started. However, in the processor according to the invention this is different for the execution of operations that require many operands.

In the processor according to the invention the functional unit 12a is arranged to execute a computation that requires more than two operands. The execution unit 126 starts this computation in response to an instruction that will be called the original instruction. The computation uses operands that are fetched in response to an operand selection instruction that is executed following the original instruction. The operation code of the original instruction determines what is done with the operands that are fetched in response to the operand selection instruction.

In response to the operation code of the original instruction the instruction decoder 122 supplies control codes to the execution unit that start the multi-operand computation. This computation proceeds through a number of instruction cycles, as delimited by the instruction clock. In one or more instruction cycles subsequent to the instruction cycle in which the original instruction cycle was issued, an operand selection instruction or operand selection instructions are issued. The operand selection instruction causes the functional unit to pass the addresses from the operand fields of the instruction to the register file 14. In response, register file 14 supplies the content of the addressed registers to execution unit 126. Instruction decoder 122 detects from the operation code of an operand selection instruction that this instruction is an operand selection instruction for the functional unit 12a. In response, instruction decoder 122 supplies an enable signal to clock gate 124 and instruction decoder 122 supplies control codes to the execution unit 126. The control codes allow execution unit 126 to proceed with the execution of the computation commanded by the original instruction, using the operands fetched in response to the operand selection instruction. When instruction decoder 122 does not detect the operand selection instruction, instruction decoder sends a signal to clock gate 124 to disable clocking of the execution unit 126. Thus, execution of the computation is suspended when no operand selection instruction is issued. This makes it possible to execute other instructions, for example with functional unit 12b, to compute the operands in the interval that the execution of the computation is suspended. Note that the suspension of execution only affects the functional unit 12a that is executing the computation commanded by the original instruction. Execution by other functional units, like functional unit 12b and other functional units (not shown) connected in parallel with the suspended functional unit 12a to the same output of the instruction issue unit 10 and the same read ports and write port of the register file, is not suspended. These functional unit may be used to compute the operands.

Of course, this is only one embodiment of the invention. In this embodiment the computation is suspended in each instruction cycle when no operand selection instruction is received, if more than one such operand selection instruction is required. In another embodiment, the computation has a more complicated execution profile, in which operands are needed only in a subset of the instruction cycles during which the computation is executed. No operands are required from the instruction cycles between the instruction cycles in which different operand selection instructions are executed. In this embodiment, execution unit 126 has an output (not shown) coupled to clock gate 124 to indicate whether an operand selection instruction is required. Clock gate 126 will disable the clock only if an operand selection instruction is required and no such instruction is detected from the operation code of the instruction. Of course, the determination whether an operand selection instruction is required may also be performed with the instruction decoder 122 and used in the generation of the disable signal to the clock gate 124.

In a further embodiment, the operand selection instruction may be executed before the operands are actually needed by the execution unit 126. In this embodiment, the operands fetched in response to the operand selection instruction are latched in the execution unit 126. Clock gate 16 is set to a ready state by a signal from instruction decoder 122 indicating that an operand selection instruction has been received. Clock gate 16 disables the clock when it is not in the ready state and execution unit 126 indicates that it requires the operands from the operand selection instruction. In this case, the clock is kept disabled until instruction decoder 122 signals that it has detected the operand selection instruction. Thus, the operand selection instruction can be scheduled in any instruction cycle. Execution of the computation will be suspended only if the operand selection instruction is scheduled later than a predetermined instruction cycle.

Functional unit 12a may be arranged to be responsive to result register selection instructions in a similar way as to operand selection instructions. Result register selection instructions are used for computations that have to write multiple results. These instructions specify the registers in which the results of the computation started by the original instruction must be written. As in the case of an operand selection instruction, execution by execution unit 126 is suspended when a result register selection instruction is not received in due time.

In the embodiments described so far, the operation code of the operand selection instruction (or result register selection instruction) is only used to detect that instruction in instruction decoder 122. The computation performed by the execution unit 126 may be suspended dependent on the timing of these instructions, but it is not affected otherwise. This is the embodiment that is easiest to implement. In a more complicated embodiment, the operation code of the operand selection instruction not only specifies the location of the operand, but also which of the operands is specified. Dependent on the operation code, the instruction decoder instructs the execution unit to executed the computation commanded by the original instruction in one order or another. For example, in case of a two dimensional block transform computation, the order in which the rows are processed might be selected dependent on the order in which the operand data for the rows is supplied to the execution unit 126, as indicated by the operand selection instructions. Similarly, the operation code of the result register selection instructions may be used to select the order in which the result are written back in addition to the locations.

FIG. 2 shows a functional unit for use in a processor as shown in FIG. 1. This functional unit is similar to functional unit 12a of FIG. 1, except that in the case of FIG. 2 the computation can also be suspended dependent on a data dependent signal. Similar numbers indicate similar components as in FIG. 1. For the purpose of making suspension data dependent, the instruction contains an additional field for specifying a register that contains a signal. The instruction register 120 contains a field that is coupled to a register read port 128c for reading the signal. The output of that port 128c is coupled to the clock gate 124.

In operation, the clock of the execution unit 126 is disabled unless instruction decoder 122 signals that a operand selection instruction has been detected and the signal received from read port 128c has a predetermined value. The following is an example of a symbolic program fragment that uses this feature

### START COMPUTATION

### REPEAT N TIMES UNTIL ENDOFLOOP

### PRODUCE D,S

### SELECT OPERANDS S,D

### ENDOFLOOP

This program fragment starts the multi-operand computation with the instruction “START COMPUTATION”, which is supplied to the functional unit of FIG. 2. After that, a loop body of two instructions (PRODUCE and SELECT OPERAND) is executed N times. The PRODUCE instruction produces data in register D and a signal in register S that specifies whether the data is valid. The SELECT OPERAND instruction is supplied to the functional unit of FIG. 2 to supply operands for the computation started by the START COMPUTATION instruction. The location of the operands of the SELECT OPERAND instruction is specified by the registers S and D. The computation is suspended when the signal from register S indicates that the data from register D is not valid. Thus, no conditional branch instructions are needed to handle invalid data. From the program it need not be explicit in which execution of the loop body operands are actually supplied.

It should be noted that the repeated use of registers D and S to supply operands and signals for use during the operation started by the START COMPUTATION instruction is only possible because the operands of this computation are specified and supplied successively during the computation. If the operands had to be supplied in parallel, different registers would have been needed for different executions of the loop body that produces these operands.

Note that the program fragment is merely symbolic. Instructions have been named for convenience of explanation. Instructions and operands not needed for the explanation have been omitted. In practice, the PRODUCE instruction may stand for a body of instructions that produce data in register D and a signal in register S.

The various alternative embodiments that have been discussed in the context of the functional unit 12a of FIG. 1 also apply to the functional unit of FIG. 2. For example, suspension of the computation may be limited to instruction cycles where the execution unit 126 actually needs operands.

1. A data processing apparatus, comprising
a register file with access ports;
a functional unit coupled to the access ports for receiving operands,
an instruction issue unit for issuing successive instructions from a program, the instruction issue unit being coupled to the access ports for selecting registers from which to read the operands specified in the instructions, the functional unit being arranged to start execution of a computation in response to reception of a first one of the instructions, a register in the register file for reading at least one of operands used in said computation being specified in a second one of the instructions issued by the instruction issue unit after issuing the first one of the instructions, the functional unit being arranged to suspend execution of the computation until after issue of the second one of the instructions when the second one of the instructions is not executed within a predetermined number of instruction cycles after the reception of the first one of the instructions.

2. A data processing apparatus according to claim 1, wherein each instruction comprises an operation code, the functional unit being arranged to detect the operation code of instructions issued from the instruction issue unit to the functional unit, and to suspend execution of the computation specified by the first one of the instructions until after detection of an operation code that identifies the second one of the instructions.

3. A data processing apparatus according to claim 2, wherein each of the instructions contains a field for an operand register selection code, the functional unit supplying a content of said field to the access port irrespective of the operation code.

4. A data processing apparatus according to claim 2, wherein the functional unit selects an order in which steps of the computation are executed dependent on the operation code.

5. A data processing apparatus according to claim 1, the second one of the instructions specifying a signal register in said register file, the functional unit being arranged to receive a signal from the specified signal register in response to the second one of the instructions, the functional unit suspending the computation unless the signal has a predetermined value indicating that the at least one of the operands is valid.

6. A data processing apparatus according to claim 1, the functional unit being arranged to write different parts of a result of the computation to the register file in response to respective further ones of the instructions, each further one of the instructions specifying a register in the register file for writing its part of the result.

7. A data processing apparatus according to claim 6, wherein the respective further ones of the instructions each contain an operation code and at least one reference to a register in the register file for writing one of the parts of the result, the functional unit selecting an order in which steps of the computation are executed dependent on a sequence in which the operation codes are received.

8. A data processing apparatus according to claim 6, the further ones of the instructions each specifying a result part register and a signal register in said register file, the functional unit being arranged to output the result part and a signal to the result part register and the signal register respectively, at a predetermined time relative to reception of the further instruction, the functional unit being arranged to determine whether the result part required for the further instruction is available at said time, the functional unit indicating in said signal whether or not the result part is available at said time.
